(19) United States
(12) Patent Application Publication
(10) Pub. No.: US 2023/0036263 A1
(43) Pub. Date: Feb. 2, 2023

(54) ENTITY EMBEDDINGS FOR VIRTUAL CARD NUMBER PAYMENT VERIFICATION

(71) Applicant: Capital One Services, LLC, McLean, VA (US)

(72) Inventor: Victoria Martins, Alameda, CA (US)

(21) Appl. No.: 17/386,023

(22) Filed: Jul. 27, 2021

(51) Int. Cl. G06Q 20/38; G06Q 20/40; G06Q 40/02; G06Q 20/42; G06F 16/28

(52) U.S. Cl. CPC G06Q 20/385; G06Q 20/405; G06Q 40/02; G06Q 20/42; G06F 16/288; G06Q 20/085

(57) ABSTRACT

The present disclosure provides systems and methods for calculating a similarity value between entities embedded within a vector field of a plurality of entities. The systems and methods can include receiving a first request from a first request entity to process a first payment completed via a virtual number, and accessing a database comprising a plurality of entity embeddings. The systems and methods can include retrieving a first embedding for the first request entity and a second embedding for a bound entity associated with the virtual number. After calculating a similarity value between the first request entity and the bound entity, the systems and methods can approve or deny the first request based on a similarity threshold value.

### FIELD

The present disclosure relates generally to identifying entities based on similarity values and, more particularly, to systems and methods for calculating a similarity value between entities embedded within a vector field of a plurality of entities.

### BACKGROUND

Customers and card issuers alike want to reduce the chances of fraud for purchases and transactions. One vulnerability that can exist with current digital payment systems is the use of a primary account number on a plurality of different online platforms. For example, a user may use a single credit account to make purchases at several different online retailers. In view of this account number reuse, fraudsters have a greater opportunity to intercept and fraudulently use a primary account number. Recently, the use of the virtual card numbers has emerged as a means to protect primary account numbers and prevent fraud. Virtual card numbers can be linked to a primary account, but are generated to be used at a specific online retailer. For example, a single customer can have five different virtual card numbers to be used at five different merchants, each of the card numbers being linked to a primary account. In this manner, if a single virtual card number is intercepted, it cannot be used at a non-bound merchant—i.e., a virtual card number bound to entity A cannot be used to make a purchase at entity B.

An issue that arises with virtual card numbers is inadvertent false declines using the card at a bound entity. A main cause of virtual card number false declines is when the financial institution does not recognize the name or identity of a requesting entity. Many times, this is because the merchant has changed their name or merchant identifier slightly, and the financial institution does not recognize that the requesting entity is actually the bound entity with a different identifier. Accordingly, there is a need for improved virtual number processing systems, including systems that more accurately identify if a payment requesting entity is the same as a bound entity, even if there are slight changes to the entity information associated with the bound entity.

### BRIEF SUMMARY OF THE INVENTION

Examples of the present disclosure relate generally to identifying entities based on embeddings and, more particularly, to systems and methods for calculating a similarity value between entities embedded within a vector field of a plurality of entities. The present disclosure provides systems and methods for calculating a similarity value between entities embedded within a vector field of a plurality of entities. The systems and methods can include receiving a first request from a first request entity to process a first payment completed via a virtual number, and accessing a database comprising a plurality of entities embedded in a vector field. The systems and methods can include retrieving a first embedding for the first request entity and a second embedding for a bound entity associated with the virtual number. The systems and methods can then calculate a similarity value between the first request entity and the bound entity. The similarity value can be calculated, for example, by calculating a cosine distance and/or cosine similarity between the first request entity embedding and the bound entity embedding. The systems and methods can approve or deny the first request based on a similarity threshold value.

These and other aspects of the present disclosure are described in the Detailed Description below and the accompanying figures. Other aspects and features of examples of the present disclosure will become apparent to those of ordinary skill in the art upon reviewing the following description of specific, exemplary examples of the present invention in concert with the figures. While features of the present disclosure can be discussed relative to certain examples and figures, all examples of the present disclosure can include one or more of the features discussed herein. Further, while one or more examples can be discussed as having certain advantageous features, one or more of such features can also be used with the various examples of the invention discussed herein. In similar fashion, while exemplary examples can be discussed below as device, system, or method examples, it is to be understood that such exemplary examples can be implemented in various devices, systems, and methods of the present invention.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner. In the drawings:

FIG. 1 is a diagram of an example system that can be used to implement one or more examples of the present disclosure;

FIG. 2 is a component diagram of an example embedding system, according to the present disclosure;

FIG. 3 is a flowchart of an example method for comparing entities based on embeddings, according to the present disclosure;

FIG. 4 is a flowchart of an example method for receiving transaction data and embedding the data within a vector field, according to the present disclosure;

FIGS. 5A-5C are schematics of example processes for identifying commonality between merchants for use in embedding into a vector field, according to the present disclosure; and

FIG. 6 is a flowchart of an example process for embedding and calculating similarity between bound entities and request entities, according to the present disclosure; and

FIG. 7 is a flowchart of an example process for embedding and calculating similarity between bound entities and request entities, according to the present disclosure.

### DETAILED DESCRIPTION

Examples of the present disclosure relate generally to identifying entities based on similarity values and, more particularly, to systems and methods for calculating a similarity value between entities embedded within a vector field of a plurality of entities. The systems and methods described herein are necessarily rooted in computer technology as they relate to virtual card numbers that can be created for and linked to a specific bound entity (e.g., merchant), and can only be used at the bound merchant. Ordinary debit or credit cards utilize a single card number linked to a single account, and the debit or credit cards can be used at any number of retailers. Virtual card numbers, on the other hand, are generated on a merchant-by-merchant basis, meaning a user is never required to divulge primary account information. Further, virtual card numbers are specifically used in online, electronic commerce and do not necessarily include a physical embodiment of a payment card. In addition to the use of the card numbers, the present systems and methods utilize historical transaction data to create millions of merchant embeddings. The data can be compiled into multi-dimensional representations of accounts transacting with these merchants. Implementations of the present systems and methods have shown to create embeddings with as many as 64 dimensions. Since this type of computational data can be prohibitively large, the embeddings described herein create an efficient way to review and confirm merchant information.

Throughout this disclosure, reference to an entity can be understood to mean a merchant, third-party payment processor, or other entity that communicates with a financial institution to receive payment for a good or service. A bound entity can be a merchant or other entity that is bound to a user's specific virtual card number (VCN). A requesting or request entity is a merchant or other entity that requests payment to be made for those goods or services. The similarity values described herein are the similarities determined between request merchant and bound merchant information. For example, for a VCN to work, the requesting entity must be the entity bound to the VCN (e.g., the bound entity). If the bound entity and request entity are not the same, the request can be denied. The present systems and methods use the embeddings of entity names/identifiers to determine whether the request entity and the bound entity are in fact the same, even if certain differences are present for the merchant names/identifiers.

The level of tolerance for merchant names/identifiers provided herein can decrease the number of false declines using the VCNs. For example, as merchants change names, either because of changes to branding, changes to website names, mergers with other merchants, etc., present VCN systems do not enable the financial institution to automatically alter VCN payment approval along with the altered merchant names. To use an illustration using the merchant entity Nike®, the bound entity for the VCN can be, for example, www.nikestore.com, but the requesting entity may be nike.com. Prior systems would not identify that these two entities are in fact the same, and the VCN payment may be declined. The present system can correct for this by embedding www.nikestore.com and nike.com in a vector field and calculating a similarity between the two embeddings.

Reference will now be made in detail to exemplary examples of the disclosed technology, examples of which are illustrated in the accompanying drawings and disclosed herein. Wherever convenient, the same reference numbers will be used throughout the drawings to refer to the same or like parts.

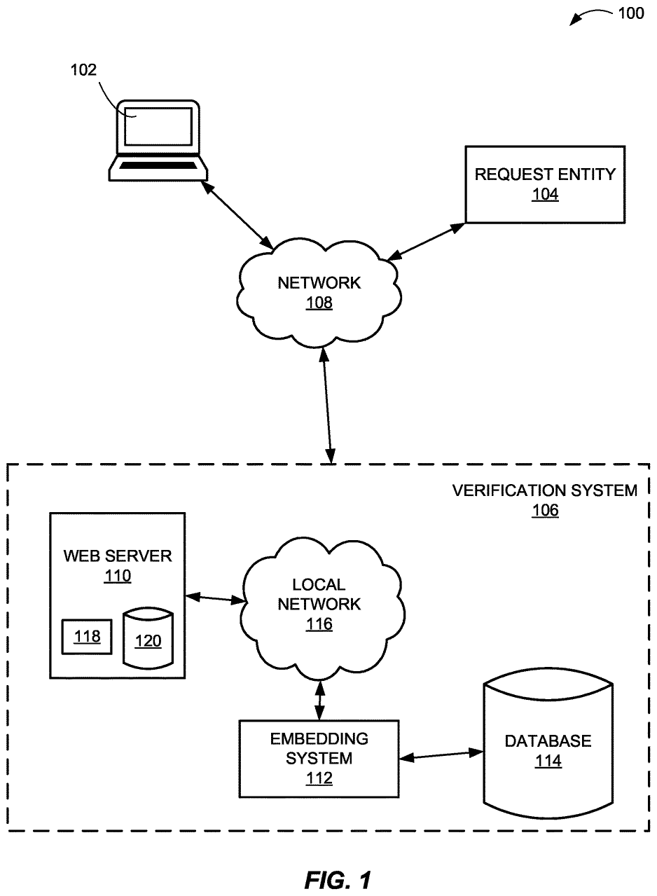

FIG. 1 is a diagram of an example system 100 that can be used to implement one or more examples of the present disclosure. A more detailed explanation of the components of the system 100 is provided below. It is beneficial, however, to provide a brief overview to describe the components of the systems and methods for embedding and comparing entity information described herein. The system 100 can include a user device 102. The user device 102 can be the computing device that is used by the customer to request a VCN and use the VCN at online retailers. The system 100 can include a request entity 104, which can be the entity that transmits a payment request to a financial institution to receive a payment for goods or services. The system 100 can include a verification system 106 that can perform the one or more processes or methods described herein for calculating the similarity values between bound and request entities.

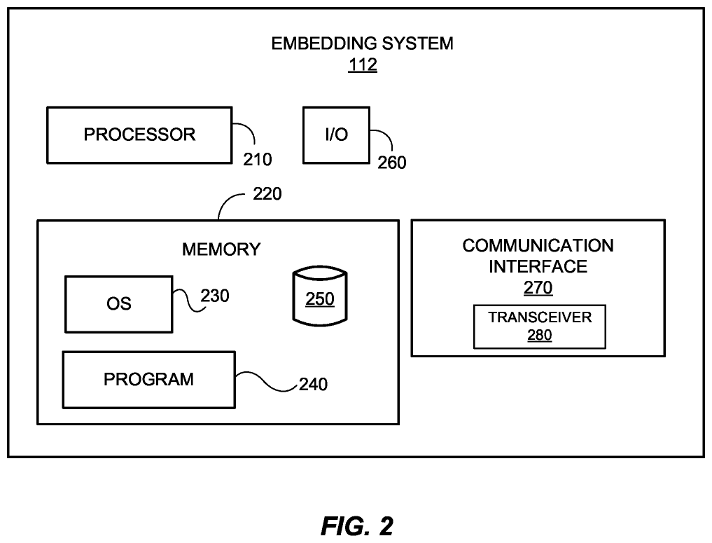

The user device 102, request entity 104, and verification system 106 can communicate via a wired or wireless network 108. The wired networks can be an Ethernet network and the wireless networks can be cellular or WiFi™ networks, for example. In some examples, network 108 can connect terminals, services, and user devices using direct connections such as WiFi™, ZigBee™, ambient backscatter communications (ABC) protocols, USB, WAN, or LAN. Because the information transmitted can be personal or confidential (e.g., it can include VCNs and purchased goods/services), the connections can also be encrypted or otherwise secured. The verification system 106 can be affiliated with a financial institution that receives payment requests from the request entity 104. The verification system 106 can include and/or communicate with an embedding system 112, which will be described in greater detail below and with respect to the component diagram shown in FIG. 2. The verification system can include one or more processors (e.g., processor 210) and memory 220 that can perform the embedding within the vector field and calculating similarity between vectors embedded within the field.

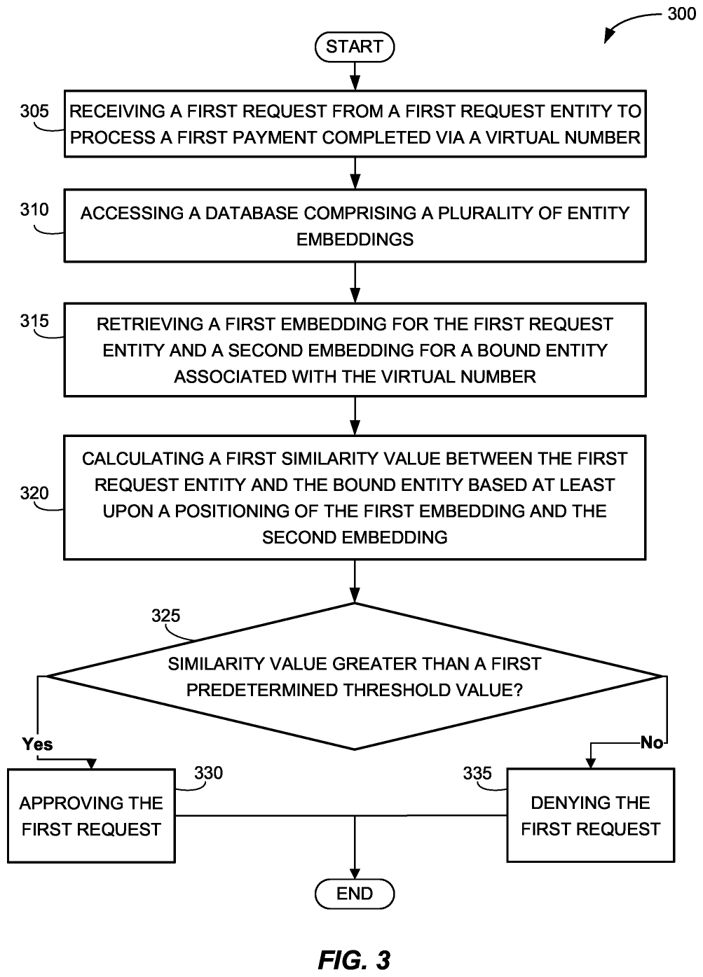

FIG. 3 is a flowchart of an example method 300 for comparing entities based on their embeddings, according to the present disclosure. The steps of method 300 can be performed by one or more components of a verification system 106 (e.g., embedding system 112 and/or web server 110). In block 305, the verification system 106 can receive, for example at a processor (e.g., processor 210), a first request from a first request entity (e.g., request entity 104) to process a first payment completed via a virtual number.

At block 310, the verification system 106 can access a database (e.g., database 114 and/or database 250) that includes a plurality of embedded entities. As described herein, the embeddings can be within a vector field. At block 315, the verification system 106 can retrieve a first embedding for the first request entity. The verification system 106 can also retrieve a second embedding for a bound entity associated with the virtual number. The bound entity information can be stored, for example, within the verification system 106 so that future purchases using the VCN (virtual number) can be processed for the bound merchant. It is contemplated that the verification system 106 is associated with the financial intuition and, as thus, can also be the entity that creates the VCN.

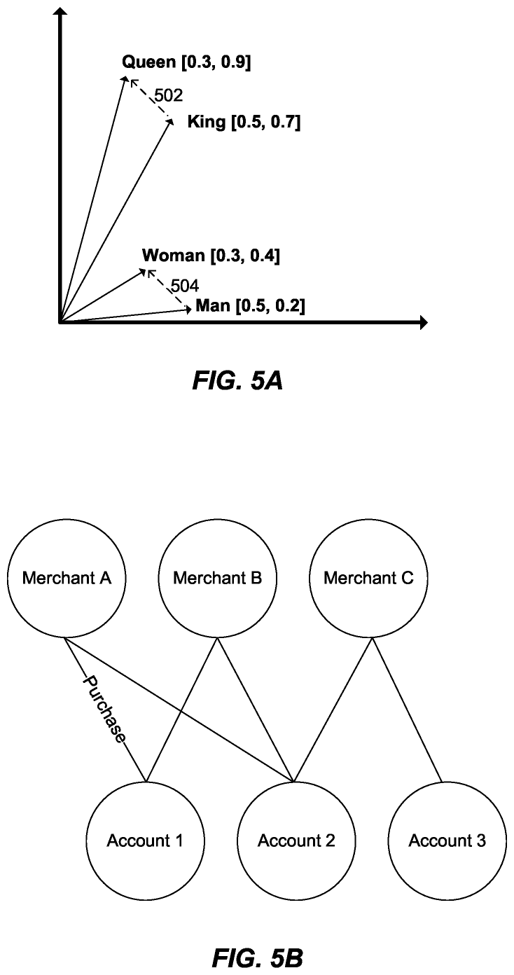

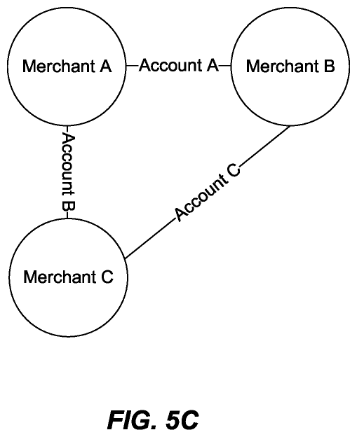

At block 320, the verification system 106 can calculate a first similarity value between the first request entity and the bound entity based at least upon a positioning of the first embedding and the second embedding. Example functions and algorithms to calculate similarities of embeddings within a space are described below with reference to FIGS. 5A-5C. At block 325, the verification system 106 can determine if the first similarity value is greater than a first predetermined threshold value (which is described in greater detail below with reference to FIGS. 5A-5C). If the similarity value is above the predetermined value threshold, block 330 includes approving the first request. In this example, the verification system 106, therefore, calculates that the request entity is the same as, or close enough to, the bound entity and the payment request is proper for that particular virtual number. If the similarity value is below the predetermined value threshold, block 335 includes denying the first request. In this example, the verification system 106, therefore, calculates that the request entity is not similar enough to the request entity, and the transaction may be fraudulent.

The systems and methods can also be used to approve or deny transactions that are made by a third-party payment provider. Certain purchases can begin at a merchant website, but can be processed with a third-party provider. To use a non-limiting example, a user may wish to purchase groceries at a Kroger®, but the payment request to the financial institution is made via Instacart®. In this example, the user may wish to use the VCN associated with Kroger®, and the system can learn that Instacart® and Kroger® are similar entities, at least for purposes of using a VCN linked to the grocer. In these examples, method 300 can include transmitting, via a transceiver (e.g., transceiver 280), a notification to a user device associated with the virtual number. The notification can ask the user to verify whether the user approved this purchase using the VCN. Method 300 can include receiving, at the processor and via the transceiver, a confirmation from the user device that the user of the user device authorized the first request. In this scenario, the first request entity can be Instacart®, which is not the bound entity for the VCN. Method 300 can include re-embedding, via the processor, the first request entity (e.g., Instacart®) closer to the bound entity (e.g., Kroger®) in the vector field.

Further, once this updated relationship is embedded, the system can use the relationship within the vector field to automatically approve VCN purchases going forward. This means that the system can approve the VCN for use at both the bound entity and the third-party provider. For example, method 300 can include receiving, at the processor, a second request from a second request entity (e.g., Kroger®) to process a second payment completed via the virtual number. Method 300 can include retrieving, via the processor, a third embedding for the second request entity, the first embedding (e.g., for the first request entity Instacart®), and the second embedding (e.g., for the bound entity Kroger®). Method 300 can include calculating, via the processor, a second similarity value between the first request entity, the bound entity, and the second request entity based at least upon the first embedding (e.g., first request entity), the second embedding (e.g., bound entity entity), and the third embedding (e.g., second request entity). Method 300 can include approving the second request when a similarity between any two of the first embedding, the second embedding, and the third embedding are greater than a second predetermined threshold value. Otherwise, method 300 can include denying the second request when the second similarity value between any two of the first embedding, the second embedding, and the third embedding is less than or equal to the second predetermined threshold value.

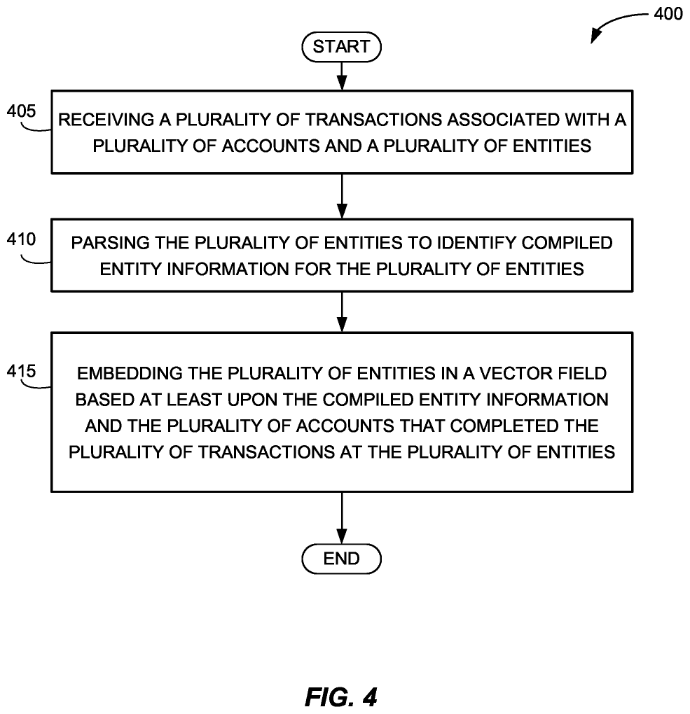

FIG. 4 is a flowchart of an example method 400 for receiving transaction data and embedding the data within a vector field, according to the present disclosure. The steps of method 400 can be performed by one or more components of a verification system 106 (e.g., embedding system 112 and/or web server 110). Method 400 can be performed alone or can accompany the method 300 described in FIG. 3. For example, method 300 describes a method of using pre-embedded entity data to calculate similarity values, while method 400 describes a method to receive transaction data and embed the information into a vector field for use with method 300.

In block 405, the verification system 106 can receive, for example at a processor (e.g., processor 210), a plurality of transactions associated with a plurality of accounts and a plurality of entities. Each of the plurality of transactions can be completed using VCNs that are associated with the plurality of accounts. For example, the plurality of accounts can be the primary account numbers that are linked to one or more VCNs for each customer. To illustrate using an example, the verification system can receive (1) an indication of Transaction A at Merchant A using VCN A associated with User A's credit card account, (2) an indication of Transaction B at Merchant B using VCN B associated with User A's credit card account, (3) an indication of Transaction C at Merchant C using VCN C associated with User B's credit card account, and (4) an indication of Transaction D at Merchant D using VCN D associated with User B's credit card account. In this fact pattern, there are four transactions (i.e., the plurality of transactions in block 405), two accounts (i.e., User A and User B's credit accounts, or the plurality of accounts in block 405), and four entities (i.e., Merchants A, B, C, and D, or the plurality of entities in block 405).

In block 410, the verification system 106 can parse the plurality of entities to identify compiled entity information for the plurality of entities. The compiled entity information can include entity name, merchant identification number, etc. In block 415, the verification system 106 can embed the plurality of entities into the vector field based at least upon the compiled entity information and the plurality of accounts that completed the plurality of transactions. Stated otherwise, the entities (e.g., merchants) can be embedded within the vector field based on their merchant information (e.g., name/etc.) and who completed the transactions.

In some aspects, method 300 or method 400 can include modifying the vector field with information related to the first request entity and the virtual number. For example, once the vector field is created, the verification system 106 can update the vector field each time a transaction is made (i.e., the first request from the first entity in method 300 of FIG. 3). Alternatively, the transaction data can be compiled over time, and the dense vector field can be updated (re-embedded) periodically (e.g., daily, weekly, monthly, etc.).

FIGS. 5A-5C are schematics of example processes for identifying commonality between merchants for use in embedding into a vector field, according to the present disclosure. FIG. 5A is a two-dimensional representation of words, which shows how words can be embedded within a space and how the embeddings can be used to determine similarity. The words can be embedded, for example, using a co-occurrence matrix that counts how often a word occurs in the context of another word. Other types of embeddings are also possible, including count vectors, term frequency—inverse document frequency vectorization, continuous bag of words, etc. In the example shown in FIG. 5A, the words Queen and King are shown embedded with a similarity 502, and the words Man and Woman are shown with the similarity 504. All four words exist in this vector space, enabling calculation of similarity based on their locations. As can be seen, the arrows shown for similarity 502 and similarity 504 both consistently encode gender across the words. The length of the arrows can be used to determine similarity between Queen and King, and Woman and Man. Alternatively, or in addition, the angle between the two vectors created between Queen and King, and Woman and Man, can be used to calculate similarities. This type of calculation using angles is known as cosine similarity calculation. Using Queen and King in FIG. 5A as an example, the angle between the two vectors for the words is roughly 15°, and cosine (15°)=0.966, meaning the two words are highly similar. If the two vectors overlapped (one on top of each other), the cosine similarity would be 1.00 (i.e., cosine (0°); if two vectors are90° apart, their similarity is 0.00 (i.e., cosine (90°)). An example formula for calculating cosine similarity of two vectors “u” and “v” is shown below in Equation 1.

$$Cosine Similarity ( u , v ) = \frac{u . v}{{‖ u ‖}_{2} {‖ v ‖}_{2}} = cos cos ( θ ) \qquad Equation 1$$

The equation above is beneficial when working with vectors in a space because it incorporates a distance component for vectors (e.g., ∥u∥₂ is the norm (or length) of vector u; and u. v is the dot product (inner product) of the two vectors).

Similar techniques as shown in FIG. 5A can be used to determine similarities between two entities embedded within a vector field. For example, by using merchant names (e.g., the plurality of entities in block 405) and who made purchases at those merchants (e.g., the plurality of accounts in block 405 of FIG. 4), the merchants can be embedded within a space. The co-occurrence matrix described above can be used to determine how often a merchant identifier occurs within the context of a plurality of financial accounts. The distance between two vectors and/or the cosine of the angle between two vectors can be used to determine if two merchants are similar to a certain degree. Then, based on a predetermined threshold value, the verification system 106 can determine if the VCN payment should be approved or denied. Using a non-limiting example of a system that calculates cosine similarity, the threshold can be set at 0.90, or a vector angle of around 25°. That predetermined threshold value, however, can be lower than 0.90, including for example, from 0.50 0.60, or 0.75, and the like. It should be noted that, although FIG. 5A provides an example vector field that is two-dimensional, the present systems and methods are not limited to two-dimensional vector representations. In fact, implementations of the present systems and methods have shown to create embeddings with as many as 64 dimensions. This can be attributed to the number of latent variables (e.g., merchant type, price points, location, etc.) that are represented in transaction patterns. This means that more than 64 dimensions are possible for the embeddings, depending on the variables used.

FIG. 5B is a schematic showing a process for identifying which accounts made purchases at which merchants, which can then be used to embed the merchants within a vector field. Each line connecting an account to a merchant is a purchase made. The ability to retrieve and store this type of account transaction information is necessarily rooted in computer technology as they relate to a financial institution that can track, store, and search transaction history for accounts that are associated with the particular financial institution. The merchants in FIG. 5B (i.e., Merchants A, Merchant B, and Merchant C) are not necessarily distinct merchants, as one of the aspects of the present disclosure is to determine whether or not they are the same merchant based on their embeddings. For example, Merchant A and Merchant B can be the same entity, but when a payment was processed, that entity had different names. To use a non-limiting example, Merchant A can be www.nikestore.com, and Merchant B can be nike.com.

Referring again to FIG. 5B, as shown, Account 1 made a purchase at both Merchant A and Merchant B, and Account 3 made a purchase at Merchant C. Merchant A and Merchant B can, therefore, be embedded in the vector field close together, and Merchant C can be embedded farther away based on this account information. FIG. 5C is an alternative schematic showing a process for identifying which accounts made purchases at which merchants, which can then be used to embed the merchants within a vector field. Each line connecting the merchants represents an account that made a transaction at both of those merchants.

Merchants can also be embedded based on the timing of when purchases were made. This can be completed for a single account that makes transactions at a plurality of different entities. For example, each time a purchase is made by a single account, a timestamp can be placed on the purchase. If a second purchase was made within a predetermined time threshold of a first purchase, the merchants associated with the second and first purchases can be deemed more similar than a merchant associated with a third purchase made outside of the predetermined time threshold. To illustrate using a non-limiting example, a single account hypothetically makes Purchase 1 at Amazon®, and then five minutes later makes Purchase 2 at Walmart®, and then 2 hours later makes Purchase 3 at Starbucks®. The system can embed Amazon® and Walmart® closer together than Amazon® and Starbucks® within the vector field based on the timestamps for those purchases.

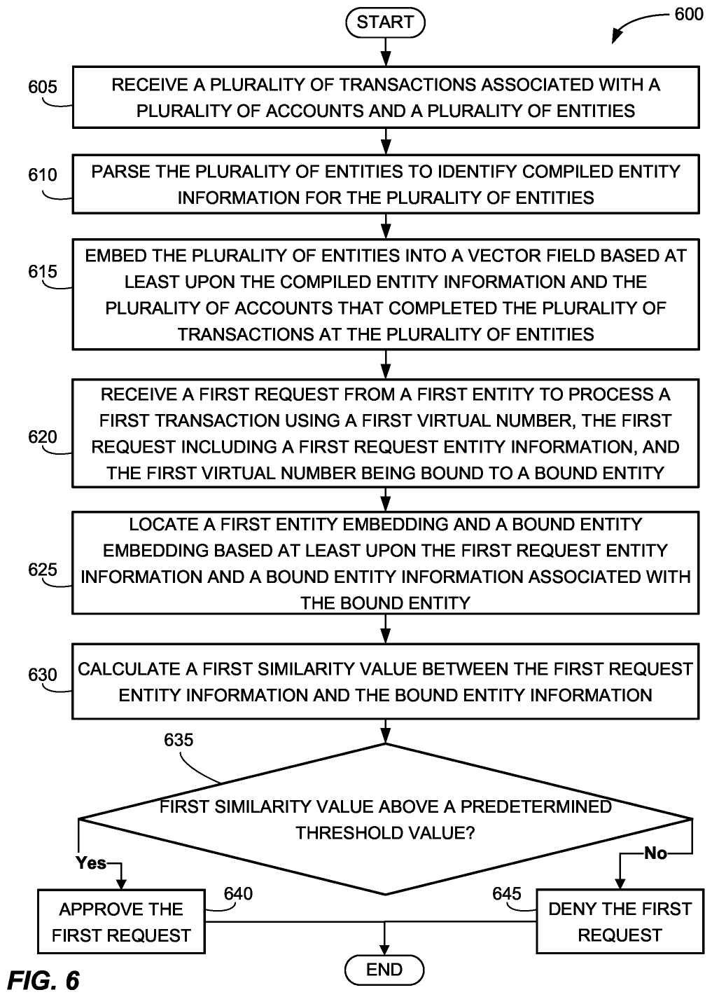

FIG. 6 is a flowchart of an example process 600 for embedding and calculating similarity between bound entities and request entities, according to the present disclosure. The steps of process 600 can be performed by one or more components of a verification system 106 (e.g., embedding system 112 and/or web server 110). At block 605, process 600 can include receiving a plurality of transactions associated with a plurality of accounts and a plurality of entities. For example, the merchant and account information described above with reference to FIGS. 5B and 5C can be received by searching payment history information.

At block 610, process 600 can include parsing the plurality of entities to identify compiled entity information for the plurality of entities. This step can include identifying merchant name and/or merchant identifiers for each of the entities in the payment history information. At block 615, process 600 can include embedding the plurality of entities into a vector field based at least upon the compiled entity information and the plurality of accounts that completed the plurality of transactions at the plurality of entities (e.g., as described above with reference to FIGS. 5B and 5C).

At block 620, process 600 can include receiving a first request from a first entity to process a first transaction using a first virtual number. The first request can include a first request entity information (e.g., name of the merchant). The first virtual number can be linked to a bound entity.

At block 625, process 600 can include locating the first entity and the bound entity embeddings based at least upon the first request entity information and a bound entity information associated with the bound entity (e.g., bound merchant name). At block 630, process 600 can include calculating a first similarity value between the first request entity information and the bound entity information. This can include calculating the cosine similarity and/or cosine distance between the embeddings of the first request entity and the bound entity.

At block 635, process 600 can include determining whether the first similarity value is above a predetermined threshold value, as described above. When the first similarity value between the first request entity embedding and the bound entity embedding is greater than a predetermined threshold value, block 640 of process 600 includes approving the first request. When the first similarity value between the first request entity embedding and the bound entity embedding is less than or equal to the predetermined threshold value, block 645 of process 600 includes denying the first request. Process 600 can end after block 640 or block 645. In other examples, additional steps can be performed according to the examples described herein (including the examples described above for method 300 in FIG. 3 and method 400 in FIG. 4).

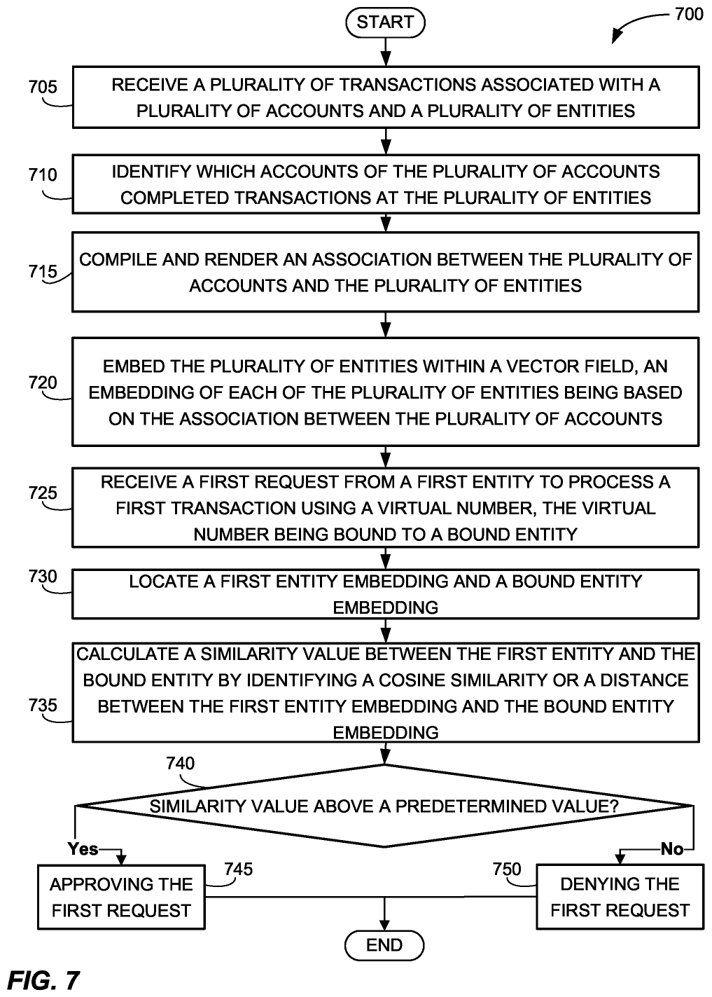

FIG. 7 is a flowchart of an example process 700 for embedding and calculating similarity between bound entities and request entities, according to the present disclosure. The steps of process 700 can be performed by one or more components of a verification system 106 (e.g., embedding system 112 and/or web server 110). At block 705, process 700 can include receiving a plurality of transactions associated with a plurality of accounts and a plurality of entities. At block 710, process 700 can include identifying which accounts of the plurality of accounts completed transactions at the plurality of entities. This information can be received by searching payment history information. At block 715, process 700 can include compiling and rendering an association between the plurality of accounts and the plurality of entities. This step can be similar to the identification techniques described above with reference to FIGS. 5A-5C.

At block 720, process 700 can include embedding the plurality of entities within a vector field. An embedding of each of the plurality of entities can be based on the association between the plurality of accounts, as described above with reference to FIGS. 5B and 5C.

At block 725, process 700 can include receiving a first request from a first entity to process a first transaction using a virtual number. The virtual number can be linked to a bound entity. At block 730, process 700 can include retrieving the first entity and the bound entity embeddings. At block 735, process 700 can include calculating a similarity value between the first entity and the bound entity by identifying a cosine similarity or a distance between the first entity and the bound entity embeddings, as described above.

At block 740, process 700 can include determining whether the similarity value is above a predetermined threshold value, as described above. When the similarity value is greater than or equal to a predetermined threshold value, block 745 of process 700 can include approving the first request. When the similarity value is less than or equal to the predetermined threshold value, block 750 of process 700 can include denying the first request. Process 700 can end after block 745 or block 750. In other examples, additional steps can be performed according to the examples described herein (including the examples described above for method 300 in FIG. 3 and method 400 in FIG. 4).

Referring again to the system 100 described, the components and arrangements shown in FIG. 1 are not intended to limit the disclosed embodiments as the components used to implement the disclosed processes, and features may vary. As shown, system 100 may interact with a user device 102 via a network 108. In certain example implementations, the system 100 can include a web server 110 and a local network 116, embedding system 112, and a database 114.

In some embodiments, a customer may operate the user device 102, for example to make an online, electronic purchase using a VCN. The user device 102 can include one or more of a mobile device, smart phone, general purpose computer, tablet computer, laptop computer, telephone, PSTN landline, smart wearable device, voice command device, other mobile computing device, or any other device capable of communicating with the network 108 and ultimately communicating with one or more components of the system 100.

The network 108 may include any type of computer networking arrangement used to exchange data. For example, the network 108 may be the Internet, a private data network, virtual private network using a public network, and/or other suitable connection(s) that enable(s) components in the system 100 environment to send and receive information between the components of the system 100. The network 108 may also include a public switched telephone network (“PSTN”) and/or a wireless network.

In accordance with certain example implementations, a request entity 104, e.g., the party seeking payment from the financial institution by processing a payment using a VCN, may be in communication with the system 100 via the network 108. In certain implementations, the request entity 104 can include a computer system associated with an entity (other than the entity associated with the system 100 and its customers) that performs one or more functions associated with the customers, i.e., processing payments for goods or services.

The system 100 may be associated with and optionally controlled by one or more entities such as a business, corporation, individual, partnership, or any other entity that provides one or more of goods, services, and consultations to individuals such as customers. The system 100 may include one or more servers and computer systems for performing one or more functions associated with products and/or services that the organization provides. Such servers and computer systems may include, for example, the web server 110 as well as any other computer systems necessary to accomplish tasks associated with the organization or the needs of customers (which may be customers of the entity associated with the organization). The web server 110 may include a computer system configured to generate and provide one or more websites accessible to customers, as well as any other individuals involved in an organization's normal operations. The web server 110, for example, may include a computer system configured to receive communications from the user device 102 via for example, a mobile application, a chat program, an instant messaging program, a voice-to-text program, an SMS message, email, or any other type or format of written or electronic communication. The web server 110 may have one or more processors 118 and one or more web server databases 120, which may be any suitable repository of website data. Information stored in the web server 110 may be accessed (e.g., retrieved, updated, and added to) via the local network 116 (and/or the network 108) by one or more devices (e.g., the embedding system 112) of the system 100.

The local network 116 may include any type of computer networking arrangement used to exchange data in a localized area, such as WiFi, Bluetooth™ Ethernet, and other suitable network connections that enable components of the system 100 to interact with one another and to connect to the network 108 for interacting with components in the system 100 environment. In some embodiments, the local network 116 may include an interface for communicating with or linking to the network 108. In other embodiments, certain components of the system 100 may communicate via the network 108, without a separate local network 116.

In accordance with certain example implementations of the disclosed technology, the verification system 106 may include one or more computer systems configured to compile data from a plurality of sources, such as the web server 110, the embedding system 112, and/or the database 114. The embedding system 112 may correlate compiled data, analyze the compiled data, arrange the compiled data, generate derived data based on the compiled data, and store the compiled and derived data in a database such as the database 114. According to some embodiments, the database 114 may be a database associated with an organization and/or a related entity that stores a variety of information relating to customers, transactions, and business operations. The database 114 may also serve as a back-up storage device and may contain data and information that is also stored on, for example, databases 120 and 250, as discussed with reference to FIG. 2.

Referring again to FIG. 2, the embedding system 112 may include a processor 210, an input/output (“I/O”) device 260, a memory 220 containing an operating system (“OS”) 230 and a program 240. In certain example implementations, the embedding system 112 may be a single server or may be configured as a distributed computer system including multiple servers or computers that interoperate to perform one or more of the processes and functionalities associated with the disclosed embodiments. In some embodiments, the embedding system 112 may further include a peripheral interface, a communication interface 270 (including for example a transceiver 280), a mobile network interface in communication with the processor 210, a bus configured to facilitate communication between the various components of the embedding system 112, and a power source configured to power one or more components of the embedding system 112.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver 280 may be configured to communicate with compatible devices and ID tags when they are within a predetermined range. A transceiver 280 may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 220 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 220.

The processor 210 may be one or more known processing devices, such as, but not limited to, a microprocessor from the Pentium™ family manufactured by Intel™ or the Turion™ family manufactured by AMD™. The processor 210 may constitute a single core or multiple core processor that executes parallel processes simultaneously. For example, the processor 210 may be a single core processor that is configured with virtual processing technologies. In certain embodiments, the processor 210 may use logical processors to simultaneously execute and control multiple processes. The processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the embedding system 112 may include one or more storage devices configured to store information used by the processor 210 (or other components) to perform certain functions related to the disclosed embodiments. In one example, the embedding system 112 may include the memory 220 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the embedding system 112 may include a memory 220 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the embedding system 112 may include the memory 220 that may include one or more programs 240 to perform one or more functions of the disclosed embodiments. For example, in some embodiments, the embedding system 112 may additionally manage dialogue and/or other interactions with the customer via a program 240.

The processor 210 may execute one or more programs 240 located remotely from the system 100 (such as the system shown in FIG. 1). For example, the system 100 may access one or more remote programs 240, that, when executed, perform functions related to disclosed embodiments.

The memory 220 may include one or more memory devices that store data and instructions used to perform one or more features of the disclosed embodiments. The memory 220 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 220 may include software components that, when executed by the processor 210, perform one or more processes consistent with the disclosed embodiments. In some embodiments, the memory 220 may include an embedding system database 250 for storing related data to enable the embedding system 112 to perform one or more of the processes and functionalities associated with the disclosed embodiments.

The embedding system 112 may include stored data relating to weighting sub-score, phone numbers, emails, and user device locations associated with a plurality of users. According to some embodiments, the functions provided by a categorizing database 250 may also be provided by a database that is external to the embedding system 112, such as the database 114 as shown in FIG. 1.

The embedding system 112 may also be communicatively connected to one or more memory devices (e.g., databases) locally or through a network. The remote memory devices may be configured to store information and may be accessed and/or managed by the embedding system 112. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The embedding system 112 may also include one or more I/O devices 260 that may comprise one or more interfaces for receiving signals or input from devices and providing signals or output to one or more devices that allow data to be received and/or transmitted by the embedding system 112. For example, the embedding system 112 may include interface components, which may provide interfaces to one or more input devices, such as one or more keyboards, mouse devices, touch screens, track pads, trackballs, scroll wheels, digital cameras, microphones, sensors, and the like, that enable the embedding system 112 to receive data from a use (such as, for example, via the user device 102).

In example embodiments of the disclosed technology, the embedding system 112 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the present disclosure has been described in connection with a plurality of exemplary aspects, as illustrated in the various figures and discussed above, it is understood that other similar aspects can be used, or modifications and additions can be made, to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

The components described in this disclosure as making up various elements of the systems and methods are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Examples of the present disclosure can be implemented according to at least the following clauses:

Clause 1: A method for comparing entities based on embeddings, the method comprising: receiving, at a processor, a first request from a first request entity to process a first payment completed via a virtual number; accessing, via the processor, a database comprising a plurality of entity embeddings; retrieving, via the processor, a first embedding for the first request entity and a second embedding for a bound entity associated with the virtual number; calculating, via the processor, a first similarity value between the first request entity and the bound entity based at least upon a positioning of the first embedding and the second embedding; and when the first similarity value between the first embedding and the second embedding is greater than a first predetermined threshold value, approving the first request; and when the first similarity value between the first embedding and the second embedding are less than or equal to the first predetermined threshold value, denying the first request.

Clause 2: The method of Clause 1, further comprising: receiving, at the processor, a plurality of transactions associated with a plurality of accounts and a plurality of entities; parsing the plurality of entities to identify compiled entity information for the plurality of entities; and embedding the plurality of entities in a vector field based at least upon the compiled entity information and the plurality of accounts that completed the plurality of transactions at the plurality of entities.

Clause 3: The method of Clause 2, further comprising modifying the plurality of entity embeddings with information related to the first request entity.

Clause 4: The method of any of Clauses 1 to 3, further comprising modifying the plurality of entity embeddings periodically based on which accounts of a plurality of accounts are completing transactions at a plurality of entities.

Clause 5: The method of any of Clauses 1 to 4, wherein the first similarity value between the first request entity and the bound entity is calculated based on a cosine similarity analysis between the first embedding and the second embedding.

Clause 6: The method of any of Clauses 1 to 5, wherein the first similarity value between the first request entity and the bound entity is calculated based on a distance between the first embedding and the second embedding.

Clause 7: The method of any of Clauses 1 to 6, further comprising embedding, via the processor, a plurality of entities in a vector field based on a co-occurrence of accounts transacting at the plurality of entities.

Clause 8: The method of Clause 7, wherein: the first request entity comprises a first request entity name; the bound entity comprises a bound entity name; and the first similarity value between the first embedding and the second embedding is based at least upon locations of the first request entity name and the bound entity name within the vector field.

Clause 9: The method of any of Clauses 1 to 8, further comprising: transmitting, via a transceiver, a notification to a user device associated with the virtual number; receiving, at the processor and via the transceiver, a confirmation from the user device that a user of the user device authorized the first request; and re-embedding, via the processor, the first request entity closer to the bound entity in a vector field, wherein the first request entity is associated with an entity other than the bound entity.

Clause 10: The method of Clause 9, further comprising: receiving, at the processor, a second request from a second request entity to process a second payment completed via the virtual number; retrieving, via the processor, a third embedding for the second request entity, the first embedding, and the second embedding; calculating, via the processor, a second similarity value between the first request entity, the bound entity, and the second request entity based at least upon the first embedding, the second embedding, and the third embedding; and either: approving the second request when a similarity between any two of the first embedding, the second embedding, and the third embedding are greater than a second predetermined threshold value; or denying the second request when the second similarity value between any two of the first embedding, the second embedding, and the third embedding are less than or equal to the second predetermined threshold value.

Clause 11: A system for embedding and calculating similarity between bound entities and request entities, the system comprising: one or more processors; and a memory in communication with the one or more processors and storing instructions that are configured to cause the system to: receive a plurality of transactions associated with a plurality of accounts and a plurality of entities; parse the plurality of entities to identify compiled entity information for the plurality of entities; embed the plurality of entities into a vector field based at least upon the compiled entity information and the plurality of accounts that completed the plurality of transactions at the plurality of entities; receive a first request from a first entity to process a first transaction using a first virtual number, the first request including a first request entity information, and the first virtual number being bound to a bound entity; locate a first entity embedding and a bound entity embedding based at least upon the first request entity information and a bound entity information associated with the bound entity; calculate a first similarity value between the first request entity information and the bound entity information; and when the first similarity value between the first request entity information and the bound entity information is greater than a predetermined threshold value, approve the first request; and when the first similarity value between the first request entity information and the bound entity information is less than or equal to the predetermined threshold value, deny the first request.

Clause 12: The system of Clause 11, wherein the first similarity value between the first request entity information and the bound entity information is calculated based on a cosine similarity analysis between a first embedding of the request entity and a second embedding of the bound entity.

Clause 13: The system of any of Clauses 11 to 12, wherein the first similarity value between the first request entity information and the bound entity information is calculated based on a cosine distance between a first embedding of the first entity and a second embedding of the bound entity.

Clause 14: The system of any of Clauses 11 to 13, wherein the system embeds the plurality of entities into the vector field based on a co-occurrence of accounts using the first request entity information for the plurality of entities.

Clause 15: The system of Clause 14, wherein: the compiled entity information for the plurality of entities comprises a plurality of entity names; the first request entity information comprises a request entity name; the bound entity information comprises a bound entity name; and the first similarity value between the first request entity information and the bound entity information is based at least upon embeddings for the request entity name and the bound entity name within the vector field.

Clause 16: The system of any of Clauses 11 to 15, wherein the instructions are further configured to cause the system to relearn embeddings based on receipt of the first request.

Clause 17: The system of any of Clauses 11 to 16, wherein: the first entity is associated with an entity other than the bound entity; and the instructions are further configured to cause the system to: transmit a notification to a user device associated with a first account that completed the first transaction; receive a confirmation from the user device that the first account completed the first transaction; and re-embed the first entity closer to the bound entity in the vector field.

Clause 18: The system of Clause 17, wherein the instructions are further configured to cause the system to: receive a second request from a second entity to process a second transaction using the first virtual number, the second request including a second request entity information; locating embeddings for the second entity, the first entity, and the bound entity based at least upon the first request entity information, the second request entity information, and the bound entity information;

calculate a second similarity value between the first request entity information, the second request entity information, and the bound entity information; when the second similarity value between any two of the first request entity information, the second request entity information, or the bound entity is greater than or equal to a second predetermined threshold value, approve the second request; and when the first similarity value between any two of the first request entity information, the second request entity information, or the bound entity is greater than or equal to the second predetermined threshold value, approve the second request, wherein the second entity is associated with the bound entity.

Clause 19: A system for embedding and calculating similarity between bound entities and request entities, the system comprising: one or more processors; and a memory in communication with the one or more processors and storing instructions that are configured to cause the system to: receive a plurality of transactions associated with a plurality of accounts and a plurality of entities; identify which accounts of the plurality of accounts completed transactions at the plurality of entities; compile and render an association between the plurality of accounts and the plurality of entities;

embed the plurality of entities within a vector field, an embedding of each of the plurality of entities being based on the association between the plurality of accounts; receive a first request from a first entity to process a first transaction using a virtual number, the virtual number being bound to a bound entity; locate a first entity embedding and a bound entity embedding; calculate a similarity value between the first entity and the bound entity by identifying a cosine similarity or a distance between the first entity embedding and the bound entity embedding; when the similarity value is greater than or equal to a predetermined threshold value, approve the first request; and when the similarity value is less than or equal to the predetermined threshold value, deny the first request.

Clause 20: The system of Clause 19, wherein the instructions are further configured to cause the system to: create the virtual number for the bound entity; and update the embedding for the plurality of entities based on the first request.

### Exemplary Use Cases

The following exemplary use cases describe examples of a typical user flow pattern. They are intended solely for explanatory purposes and not limitation.

In an effort to combat account fraud, National Bank creates a virtual card number (VCN) system that enables users to create account numbers for each online merchant at which they shop. Each VCN for a particular customer can be linked to a customer's primary account at National Bank. Over the course of time, National Bank noticed a small percentage of their VCN payment requests were being denied, even though they were being used at the proper merchant. This occurred, for example, when the requesting entity's name was slightly different than the original bound entity's name when the customers set up the VCNs. To combat these false declines, National Bank instituted a verification system as described herein.

Since National Bank is able to track purchases made over time, it could receive transaction history indicating which customers were making purchases at which merchants. Using the customer accounts and merchant names, National Bank created merchant embeddings over a period of time. National Bank stores these merchant embeddings in a database, and uses the embeddings to identify when a payment request entity is the same as a bound entity, even if there are certain differences in the names of the request and bound entities.

Sarah, a National Bank customer with a credit account at the bank, takes advantage of the VCN service and creates a single-merchant VCN to use at Lululemon®'s online store, and the VCN is linked to her credit card account. When creating the VCN, Sarah linked the VCN to www.lululemon.com. A few days later, Sarah attempts a purchase at www.lululemon.com using the VCN. When requesting payment, Lululemon sends National Bank a payment request from the entity “lululemoncom*.” Ordinarily, this could cause a false decline since the requesting entity lululemoncom* is different than the bound entity www.lululemon.com. However, National Bank accesses its database of merchant embeddings, locates a first embedding for lululemoncom* and a second embedding for www.lululemon.com, and calculates the similarity between the two entity embeddings. In this case, using cosine similarity, National Bank finds a similarity of 0.83. Since National Bank has a predetermined threshold value of 0.75, it approves Lululemon®'s payment request.

About a week later, National Bank receives another payment request using Sarah's VCN, this time from AthleisureStoreCom. National Bank accesses its database of merchant embeddings, locates a first embedding for AthleisureStoreCom and a second embedding for www.lululemon.com (the bound entity for the VCN), and calculates the similarity between the two entity embeddings. This time, the similarity between the request entity and the bound entity is only 0.24, so National Bank denies the transaction as potential fraud.

Jim, another National Bank customer, also creates a personalized VCN for use at Publix® grocery stores, via www.publix.com. Jim attempts to use his VCN at Publix®, but the payment is completed by the company Instacart®. To this end, National Bank receives a payment request from Instacart® instead of www.publix.com (the bound entity). National Bank accesses its database of merchant embeddings, locates a first embedding for Instacart® and a second embedding for www.publix.com (the bound entity), and calculates the similarity of 0.40 between the two entities. In this scenario, however, National Bank sends Jim a notification asking if he attempted the purchase, to which Jim confirms. National Bank then approves the purchase. At certain volumes of co-occurrence, the embeddings for Instacart® and www.publix.com become more similar such that, in a subsequent purchase, National Bank can identify these two as related entities for use with a VCN.

What is claimed is:

1. A method for comparing entities based on embeddings, the method comprising:
receiving, at a processor, a first request from a first request entity to process a first payment completed via a virtual number;
accessing, via the processor, a database comprising a plurality of entity embeddings;
retrieving, via the processor, a first embedding for the first request entity and a second embedding for a bound entity associated with the virtual number;
calculating, via the processor, a first similarity value between the first request entity and the bound entity based at least upon a positioning of the first embedding and the second embedding; and
when the first similarity value between the first embedding and the second embedding is greater than a first predetermined threshold value, approving the first request; and
when the first similarity value between the first embedding and the second embedding are less than or equal to the first predetermined threshold value, denying the first request.

2. The method of claim 1, further comprising:
receiving, at the processor, a plurality of transactions associated with a plurality of accounts and a plurality of entities;
parsing the plurality of entities to identify compiled entity information for the plurality of entities; and
embedding the plurality of entities in a vector field based at least upon the compiled entity information and the plurality of accounts that completed the plurality of transactions at the plurality of entities.

3. The method of claim 2, further comprising modifying the plurality of entity embeddings with information related to the first request entity.

4. The method of claim 1, further comprising modifying the plurality of entity embeddings periodically based on which accounts of a plurality of accounts are completing transactions at a plurality of entities.

5. The method of claim 1, wherein the first similarity value between the first request entity and the bound entity is calculated based on a cosine similarity analysis between the first embedding and the second embedding.

6. The method of claim 1, wherein the first similarity value between the first request entity and the bound entity is calculated based on a distance between the first embedding and the second embedding.

7. The method of claim 1, further comprising embedding, via the processor, a plurality of entities in a vector field based on a co-occurrence of accounts transacting at the plurality of entities.

8. The method of claim 7, wherein:
the first request entity comprises a first request entity name;
the bound entity comprises a bound entity name; and
the first similarity value between the first embedding and the second embedding is based at least upon locations of the first request entity name and the bound entity name within the vector field.

9. The method of claim 1, further comprising:
transmitting, via a transceiver, a notification to a user device associated with the virtual number;
receiving, at the processor and via the transceiver, a confirmation from the user device that a user of the user device authorized the first request; and
re-embedding, via the processor, the first request entity closer to the bound entity in a vector field,
wherein the first request entity is associated with an entity other than the bound entity.

10. The method of claim 9, further comprising:
receiving, at the processor, a second request from a second request entity to process a second payment completed via the virtual number;
retrieving, via the processor, a third embedding for the second request entity, the first embedding, and the second embedding;
calculating, via the processor, a second similarity value between the first request entity, the bound entity, and the second request entity based at least upon the first embedding, the second embedding, and the third embedding; and
either:
approving the second request when a similarity between any two of the first embedding, the second embedding, and the third embedding are greater than a second predetermined threshold value; or
denying the second request when the second similarity value between any two of the first embedding, the second embedding, and the third embedding are less than or equal to the second predetermined threshold value.

11. A system for embedding and calculating similarity between bound entities and request entities, the system comprising:
one or more processors; and
a memory in communication with the one or more processors and storing instructions that are configured to cause the system to:
receive a plurality of transactions associated with a plurality of accounts and a plurality of entities;
parse the plurality of entities to identify compiled entity information for the plurality of entities;
embed the plurality of entities into a vector field based at least upon the compiled entity information and the plurality of accounts that completed the plurality of transactions at the plurality of entities;
receive a first request from a first entity to process a first transaction using a first virtual number, the first request including a first request entity information, and the first virtual number being bound to a bound entity;
locate a first entity embedding and a bound entity embedding based at least upon the first request entity information and a bound entity information associated with the bound entity;
calculate a first similarity value between the first request entity information and the bound entity information; and
when the first similarity value between the first request entity information and the bound entity information is greater than a predetermined threshold value, approve the first request; and
when the first similarity value between the first request entity information and the bound entity information is less than or equal to the predetermined threshold value, deny the first request.

12. The system of claim 11, wherein the first similarity value between the first request entity information and the bound entity information is calculated based on a cosine similarity analysis between a first embedding of the request entity and a second embedding of the bound entity.

13. The system of claim 11, wherein the first similarity value between the first request entity information and the bound entity information is calculated based on a cosine distance between a first embedding of the first entity and a second embedding of the bound entity.

14. The system of claim 11, wherein the system embeds the plurality of entities into the vector field based on a co-occurrence of accounts using the first request entity information for the plurality of entities.

15. The system of claim 14, wherein:
the compiled entity information for the plurality of entities comprises a plurality of entity names;
the first request entity information comprises a request entity name;
the bound entity information comprises a bound entity name; and
the first similarity value between the first request entity information and the bound entity information is based at least upon embeddings for the request entity name and the bound entity name within the vector field.

16. The system of claim 11, wherein the instructions are further configured to cause the system to relearn embeddings based on receipt of the first request.

17. The system of claim 11, wherein:
the first entity is associated with an entity other than the bound entity; and
the instructions are further configured to cause the system to:
transmit a notification to a user device associated with a first account that completed the first transaction;
receive a confirmation from the user device that the first account completed the first transaction; and
re-embed the first entity closer to the bound entity in the vector field.

18. The system of claim 17, wherein the instructions are further configured to cause the system to:
receive a second request from a second entity to process a second transaction using the first virtual number, the second request including a second request entity information;
locating embeddings for the second entity, the first entity, and the bound entity based at least upon the first request entity information, the second request entity information, and the bound entity information;
calculate a second similarity value between the first request entity information, the second request entity information, and the bound entity information;
when the second similarity value between any two of the first request entity information, the second request entity information, or the bound entity is greater than or equal to a second predetermined threshold value, approve the second request; and
when the first similarity value between any two of the first request entity information, the second request entity information, or the bound entity is greater than or equal to the second predetermined threshold value, approve the second request,
wherein the second entity is associated with the bound entity.

19. A system for embedding and calculating similarity between bound entities and request entities, the system comprising:
one or more processors; and
a memory in communication with the one or more processors and storing instructions that are configured to cause the system to:
receive a plurality of transactions associated with a plurality of accounts and a plurality of entities;
identify which accounts of the plurality of accounts completed transactions at the plurality of entities;
compile and render an association between the plurality of accounts and the plurality of entities;
embed the plurality of entities within a vector field, an embedding of each of the plurality of entities being based on the association between the plurality of accounts;
receive a first request from a first entity to process a first transaction using a virtual number, the virtual number being bound to a bound entity;
locate a first entity embedding and a bound entity embedding;
calculate a similarity value between the first entity and the bound entity by identifying a cosine similarity or a distance between the first entity embedding and the bound entity embedding;
when the similarity value is greater than or equal to a predetermined threshold value, approve the first request; and
when the similarity value is less than or equal to the predetermined threshold value, deny the first request.

20. The system of claim 19, wherein the instructions are further configured to cause the system to:
create the virtual number for the bound entity; and
update the embedding for the plurality of entities based on the first request.
